(19) United States
(12) Patent Application Publication
(10) Pub. No.: US 2011/0019836 A1
(43) Pub. Date: Jan. 27, 2011

(54) SOUND PROCESSING APPARATUS

(75) Inventors: Toshiaki Ishibashi, Fukuroi-shi (JP); Satoshi Ukai, Hamamatsu-shi (JP)

Correspondence Address: ROSSI, KIMMS & McDOWELL LLP., 20609 Gordon Park Square, Suite 150, Ashburn, VA, 20147, US

(73) Assignee: YAMAHA CORPORATION, Hamamatsu-shi, Shizuoka (JP)

(21) Appl. No.: 12/934,757

(22) PCT Filed: Mar. 27, 2009
(86) PCT No.: PCT/JP2009/056382

§ 371 Date: Sep. 27, 2010

(30) Foreign Application Priority Data
Mar. 27, 2008 (JP) 2008-082511 2008
Mar. 17, 2009 (JP) 2009-064510 2009

(51) Int. Cl. H04R 3/00

(52) U.S. Cl. 381/92

(57) ABSTRACT

A sound emission and collection device includes a main housing and two sub-housings. In the main housing, a microphone array is provided. Microphone arrays are also provided in the sub-housings. Sound collection directions of the microphone arrays are outer directions which are opposite a side of the main housing. The sub-housings are rotatably connected to the main housing. The sound emission and collection device generates a plurality of collected sound beam signals MB10 to MB12 based on a collected sound of each of the microphone arrays according to the rotation amounts of the sub-housings with respect to the main housing and performs phase control and addition processing.

### TECHNICAL FIELD

This invention relates to a sound processing apparatus which generates a collected sound beam signal by performing sound collection control according to the rotation amounts of a plurality of connected microphone arrays.

### BACKGROUND ART

Conventionally, various sound processing apparatuses which suppress audio feedback, echo, and the like occurring when a microphone collects a sound signal emitted from a speaker have been proposed (for example, refer to Patent Citation 1).

In a voice conference apparatus of Patent Citation 1, a speaker is provided on the middle of a housing and microphones are provided on four corners of the housing. Each of the microphones is covered with an elastic body and is made to protrude to the outside of the housing, so that an emitted sound signal from the speaker which has propagated through the housing is not collected by the microphone of the voice conference apparatus of Patent Citation 1.

Patent Citation 1: JP-A-08-298696

### DISCLOSURE OF INVENTION

### Technical Problem

In the voice conference apparatus of Patent Citation 1, however, it is not possible to collect a sound from a specific direction by controlling the sound collection directivity even though a sound can be collected from the entire periphery of the housing.

Therefore, there is provided a sound processing apparatus capable of realizing a plurality of sound collection directivity patterns, such as collecting a sound from the entire periphery or collecting a sound from a specific direction.

### Technical Solution

A sound processing apparatus of the present invention includes: a main housing in which a microphone array is provided at a side wall thereof; and a plurality of sub-housings in which microphone arrays are provided respectively. In the sound processing apparatus, the respective sub-housings are rotatably connected with both ends of one side of the main housing as the rotation center. The microphone array is provided at the one side of the main housing. The sound processing apparatus detects the rotation amount of each of the sub-housings with respect to the main housing and detects the relative position of each of the sub-housings with respect to the main housing based on the rotation amounts. The sound processing apparatus generates a plurality of collected sound beam signals on the basis of sound signals, which are collected by the microphone arrays of the main housing and each of the sub-housings, according to the relative position of the main housing with respect to each of the sub-housings.

Accordingly, the sound processing apparatus can easily change the sound collection range simply by rotating each of the sub-housings. In addition, it is possible to change the sound collection range according to a use case of the user.

Moreover, the sound processing apparatus of this invention may be configured to include a speaker in the main housing. In this case, the sound processing apparatus can suppress an emitted sound component of the speaker in a sound signal subjected to an addition processing by performing phase control and the addition processing for the collected sound beam signal.

Accordingly, the sound processing apparatus can emit a sound from the speaker and also can suppress an emitted sound component of the speaker included in the collected sound. As a result, it is possible to suppress the occurrence of audio feedback or echo and also to reduce the load of an echo canceller.

Moreover, the sound processing apparatus of this invention may be configured such that when an arrangement for all-direction sound collection, in which all directions are a sound collection range, is detected using all of the microphone arrays of the main housing and each of the sub-housings (for example, states shown in FIGS. 3, 6, and 9), the sound processing apparatus generates the plurality of collected sound beam signals by uniformly collecting a sound in all directions and also controls the phase of each collected sound beam signal on the basis of the angle formed by the main directions of the collected sound beam signals and adds the phase controlled collected sound beam signals.

Accordingly, the sound processing apparatus can suppress an emitted sound component of the speaker included in the collected sound and can also collect a sound uniformly from the entire periphery of the device.

Moreover, the sound processing apparatus of this invention may be configured such that when it is detected that ends of the microphone array of each of the sub-housings (an end opposite to the end which is connected to the main housing) do not exceed an extension line of one side of the main housing, at which the microphone array is provided, by rotation of the sub-housings different from the arrangement for all-direction sound collection (for example, states shown in FIGS. 4, 7, and 10), the sound processing apparatus generates the collected sound beam signals from a direction, which is perpendicular to the microphone array of each of the sub-housings, to a side of the positive rotation direction (direction rotating from a side wall of the sub-housing toward the extension line).

Since the sound processing apparatus does not collect a sound from the direction in which a user would not be seated, an emitted sound from the speaker is not collected wherever possible. As a result, the sound processing apparatus can further suppress a collected sound based on sound emission of the speaker.

Moreover, when the sound processing apparatus of this invention detects that each of the sub-housings exceeds an extension line of one side of the main housing, at which the microphone array is provided, by rotation of the sub-housings (for example, states shown in FIGS. 5, 8, and 11), only a collected sound beam signal based on sound collection of each of the sub-housings is added without adding a collected sound beam signal based on sound collection of the main housing.

In the sound processing apparatus, since the speaker is provided in the main housing and the microphone array of the main housing is closest to the position of the speaker, a largest amount of emitted sound signals from the speaker are included in collected sound beam signals based on sound collection of the main housing. Since the sound processing apparatus does not add a collected sound beam signal based on sound collection of the main housing, an emitted sound component of the speaker included in the collected sound can be further suppressed.

### ADVANTAGEOUS EFFECTS

Since the sound processing apparatus of this invention can easily change the sound collection range simply by rotating each of the sub-housings, the sound collection range can be changed according to a use case of a user.

### BRIEF DESCRIPTION OF DRAWINGS

FIG. 1 is a plan view at the basic posture of a sound emission and collection device of the present embodiment.

FIG. 2 is a functional block diagram of the sound emission and collection device of the present embodiment.

FIG. 3 is a view showing an example in which multiple users are seated around a sound emission and collection device.

FIG. 4 is a view showing an example in which multiple users are seated in front of a sound emission and collection device.

FIG. 5 is a view showing an example in which one user is seated in front of a sound emission and collection device.

FIG. 6 is a view showing an example in which multiple users are seated around another sound emission and collection device.

FIG. 7 is a view showing an example in which multiple users are seated in front of another sound emission and collection device.

FIG. 8 is a view showing an example in which one user is seated in front of another sound emission and collection device.

FIG. 9 is a view showing an example in which multiple users are seated around another sound emission and collection device.

FIG. 10 is a view showing an example in which multiple users are seated in front of another sound emission and collection device.

FIG. 11 is a view showing an example in which one user is seated in front of another sound emission and collection device.

### EXPLANATION OF REFERENCE

1 to 3: sound emission and collection device
10, 10′, 10″: main housing
11, 12: sub-housing
13A, 13B: rotary connection section
110: operating section
111: control section
113: input and output I/F
114: sound emission control section
116: collected sound beam forming section
117: collected sound beam mixing section
118: echo canceller
200 to 203: user
1121, 1122: rotary encoder
1150 to 1153: microphone array
MB, MB10A to MB10C, MB11A to MB11C, MB12A to MB12C, MB13A to MB13C: collected sound beam signal
MIC: microphone
SP: speaker

### BEST MODE FOR CARRYING OUT THE INVENTION

### First Embodiment

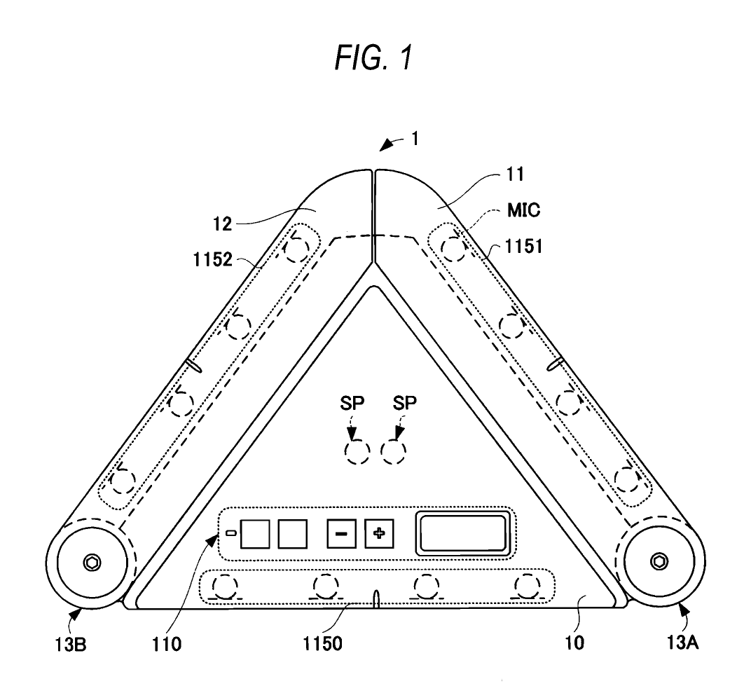

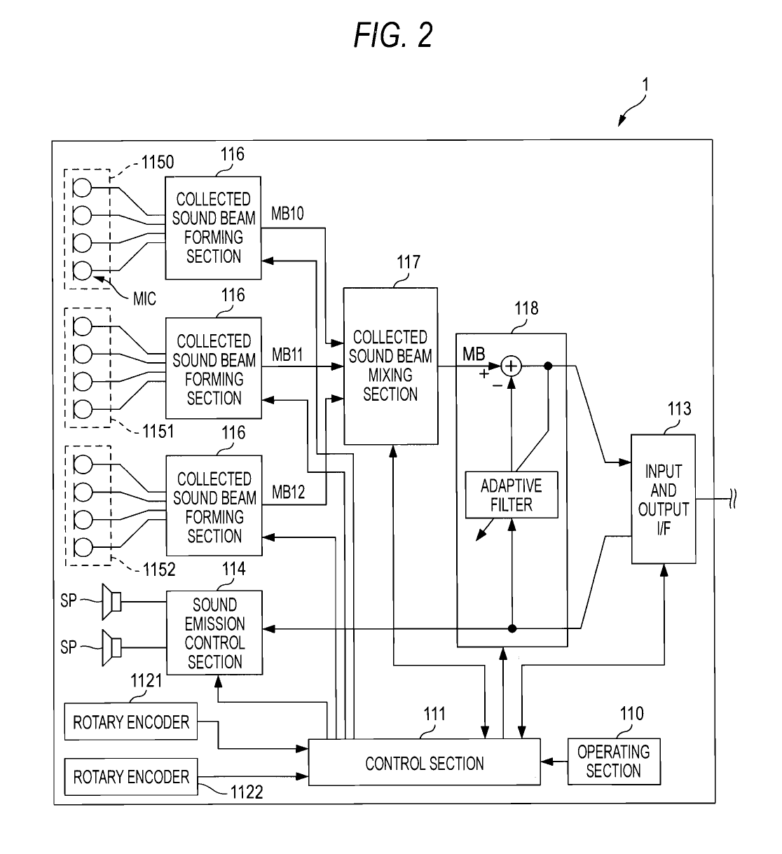

Function and configuration of a sound emission and collection device (equivalent to a sound processing apparatus of the present invention) 1 will be described with reference to FIGS. 1 and 2. FIG. 1 is a plan view at the basic posture of the sound emission and collection device of the present embodiment. FIG. 2 is a functional block diagram of the sound emission and collection device of the present embodiment. The sound emission and collection device 1 is connected to a personal computer (hereinafter, called a PC) with a communication function and performs sound communication with another sound communication device, television conference system, or the like through the PC.

As shown in FIG. 1, the sound emission and collection device 1 is mechanically configured by a main housing 10 and two sub-housings 11 and 12 which are rotatably provided with respect to the main housing 10. Moreover, in the following explanation, the number of microphones MIC provided on each of the main housing 10 and the sub-housings 11 and 12 is four, and the number of speakers SP provided in the main housing 10 is two. However, the number of microphones MIC and the number of speakers SP may be appropriately set according to the specifications.

The main housing 10 has an approximately triangular shape in plan view, and has a thickness in which the microphone MIC can be provided along a side wall thereof. The main housing 10 has three side walls. At the inner side of the front direction side wall (side wall having a wall surface in the lower direction in FIG. 1), four microphones MIC are provided with a direction from the front direction side wall to the outside as a sound collection direction. The four microphones MIC are arranged in parallel to the front direction side wall at predetermined distances, and a microphone array 1150 having a sound collection region from the front direction side wall to the outside is configured by the four microphones MIC.

An operating section 110 including a plurality of operating elements is provided on the upper surface (surface in plan view in FIG. 1) of the main housing 10. The plurality of operating elements are arranged in parallel to the front direction side wall, as shown in FIG. 1. Here, the plurality of operating elements are an operating element which receives the start and end of sound emission and collection, an operating element which receives volume adjustment of an emitted sound, and an operating element which receives microphone mute, for example.

At the inside, approximately in the vicinity of the center of the triangle in plan view of the main housing 10, two speakers SP are provided in parallel to the front direction side wall and at a distance which allows stereo speaker control. In addition, a region other than the operating section 110 of the upper surface wall of the main housing 10 and the front direction side wall are mesh-processed.

Although not shown in the drawing, a USB connection terminal, an analog audio IN terminal, an analog audio OUT terminal, and a power input terminal are provided as an input and output I/F 113 in a portion equivalent to the opposite angle of the front direction side wall of the main housing 10 (refer to FIG. 2).

Respective portions equivalent to corners of both ends of the front direction side wall of the main housing 10 are rotary connection sections 13A and 13B of the sub-housings 11 and 12. The sub-housings 11 and 12 rotate with respect to the main housing 10 with the rotary connection sections 13A and 13B as the rotation center. Rotary encoders 1121 and 1122 (refer to FIG. 2) are provided in the rotary connection sections 13A and 13B. The rotary encoder 1121 acquires a rotation detection signal corresponding to the rotation amount of the sub-housing 11, and the rotary encoder 1122 acquires a rotation detection signal corresponding to the rotation amount of the sub-housing 12.

Each of the sub-housings 11 and 12 has an approximately rectangular parallelepiped shape in which the length in its long side direction is approximately the same as one side of the triangle of the main housing 10, the length in its short side direction is a predetermined length, and the thickness is the same as that of the main housing 10. One ends of the sub-housings 11 and 12 in their long side direction are connected to the main housing 10 by the rotary connection sections 13A and 13B. In addition, the sub-housings 11 and 12 rotate in a rotation range from one end to the other end through a position at which the long side direction and the front direction side wall of the main housing 10 become parallel to each other. The one end of the rotation range is a state in which entire sides of the sub-housings 11 and 12 in the long side direction are in contact with the main housing 10. The other end of the rotation range is a position at a predetermined angle, which protrudes to the front direction more than the front direction side wall of the main housing 10.

Four microphones MIC are provided in the sub-housing 11. A sound collection direction of the four microphones MIC is the outer direction opposite the main housing 10 side (in the case shown in FIG. 1, a direction toward an upper right side) in a state that the sub-housing 11 is in contact with one side wall (in the case shown in FIG. 1, a side wall which is toward the upper right side) of the main housing 10. These microphones MIC are arranged at predetermined distances along the long side direction of the sub-housing 11. By these four microphones MIC, a microphone array 1151 having a sound collection region from the microphone MIC installation side surface of the sub-housing 11 to the outside is formed.

Four microphones MIC are provided in the sub-housing 12, A sound collection direction is the outer direction opposite the main housing 10 side (in the case shown in FIG. 1, a direction toward an upper left side) in a state that the sub-housing 12 is in contact with one side wall (in the case shown in FIG. 1, a side wall which is toward the upper left side) of the main housing 10. These microphones MIC are arranged at predetermined distances along the long side direction of the sub-housing 12. By these four microphones MIC, a microphone array 1152 having a sound collection region from the microphone MIC installation side surface of the sub-housing 12 to the outside is formed.

A collected sound signal at each microphone MIC of the microphone arrays 1151 and 1152 is given to a collected sound beam forming section 116 (refer to FIG. 2) of the main housing 10 through the rotary connection sections 13A and 13B.

Moreover, as shown in FIG. 2, the sound emission and collection device 1 includes a control section 111, a sound emission control section 114, the collected sound beam forming section 116, a collected sound beam mixing section 117 (the collected sound beam forming section 116 and the collected sound beam mixing section 117 are equivalent to a sound collection control section of the present invention), an echo canceller 118, and the speaker SP as function sections within the main housing 10 in addition to the input and output I/F 113, the operating section 110, the microphone arrays 1150 to 1152, and the rotary encoders 1121 and 1122.

The control section 111 performs overall control of the sound emission and collection device 1. The control section 111 performs control on the basis of a command input by each of the operating elements of the operating section 110. For example, when an operation input of the start and end of sound emission and collection is received, the control section 111 instructs the sound emission control section 114 to start sound emission of an emitted sound signal and to end the sound emission, and instructs the collected sound beam mixing section 117 to start the output of a collected sound beam signal MB and end the output. When an operation input of volume adjustment of an emitted sound is received, the control section 111 instructs the sound emission control section 114 to perform sound emission control of volume adjustment. When an operation input of microphone mute is received, the control section 111 instructs the collected sound beam mixing section 117 to stop the output of the collected sound beam signal MB and also makes an operator of microphone flicker.

In addition, the control section 111 acquires the sound emission directivity information from the emitted sound signal having sound emission directivity information input from the input and output I/F 113 and gives a sound emission directivity instruction to the sound emission control section 114.

In addition, the control section 111 determines sound collection directivity and a sound signal for output on the basis of the values (rotation amount) of rotation detection signals from the rotary encoders 1121 and 1122 and gives to the collected sound beam forming section 116 a sound collection directivity instruction for forming the sound collection directivity. In addition, the control section 111 gives to the collected sound beam mixing section 117 an output sound signal instruction for selecting and acquiring a sound signal for output. Whenever a change in the rotation amount is detected (whenever the rotation of the sub-housing 11 or 12 is detected), the control section 111 determines a sound signal for output and sound collection directivity corresponding to the rotation amount detected, gives a sound collection directivity instruction to the collected sound beam forming section 116, and gives an output sound signal instruction to the collected sound beam mixing section 117. In addition, details of sound collection control based on the rotation amounts of the sub-housings 11 and 12 with respect to the main housing 10 will be described later.

The input and output I/F 113 is configured as described above and is connected to a PC through a USB cable in the present embodiment. The input and output I/F 113 receives an emitted sound signal and transmits the collected sound beam signal MB. If an emitted sound signal and the sound emission directivity information are received, the input and output I/F 113 gives the sound emission directivity information to the control section 111 and gives the emitted sound signal to the sound emission control section 114 through the echo canceller 118. In addition, the input and output I/F 113 performs transmission and reception of various control signals between the control section 111 and the PC.

The sound emission control section 114 generates an individual sound emission driving signal, which is given to each of the two speakers SP, on the basis of the emitted sound signal acquired through the input and output I/F 113 and the sound emission directivity instruction from the control section 111. Specifically, the sound emission control section 114 generates an individual sound emission driving signal, which is subjected to signal processing for realizing monophonic reproduction, stereo dipole reproduction, and the like, and outputs it to the two speakers SP. In this case, the sound emission control section 114 performs signal level control of an individual sound emission driving signal in response to a sound emission control instruction of volume adjustment.

The two speakers SP are arranged at a distance which is set beforehand as described above and emit a sound using the individual sound emission driving signals. The distance between the two speakers SP and the individual sound emission driving signal given to each of the speakers SP are set beforehand so that the speakers SP function as a stereo speaker, and stereo sound emission is realized by these conditions.

The four microphones MIC of the microphone array 1150 generate a collected sound signal by collecting a sound from the outside of the front direction side wall of the main housing 10. The four microphones MIC of the microphone array 1151 generate a collected sound signal by collecting a sound from the outside of the microphone installation surface of the sub-housing 11, and the four microphones MIC of the microphone array 1152 generate a collected sound signal by collecting a sound from the outside of the microphone installation surface of the sub-housing 12.

The collected sound beam forming sections 116 generate collected sound beam signals MB10 to MB12 by performing delay processing or addition processing based on the sound collection directivity instructions given from the control section 111, on the collected sound signal in the microphones MIC of each of the microphone arrays 1150 to 1152 and outputs the collected sound beam signals MB10 to MB12 to the collected sound beam mixing section 117.

When the collected sound beam signals MB10 to MB12 are input from the collected sound beam forming sections 116 to the collected sound beam mixing section 117, the collected sound beam mixing section 117 selects a collected sound beam signal to be output on the basis of the output sound signal instruction given from the control section 111. In addition, the collected sound beam mixing section 117 performs phase control on the selected collected sound beam signal and generates the collected sound beam signal MB by addition, and outputs it to the echo canceller 118.

The echo canceller 118 includes an adaptive filter and a postprocessor having an adder. The adaptive filter generates a pseudo feedback sound signal based on the emitted sound signal and gives the pseudo feedback sound signal to the adder of the postprocessor. The adder of the postprocessor performs echo cancellation by subtracting the pseudo feedback sound signal from the collected sound beam signal MB and outputs the result to the input and output I/F 113. In this case, the postprocessor feeds the output result back to the adaptive filter.

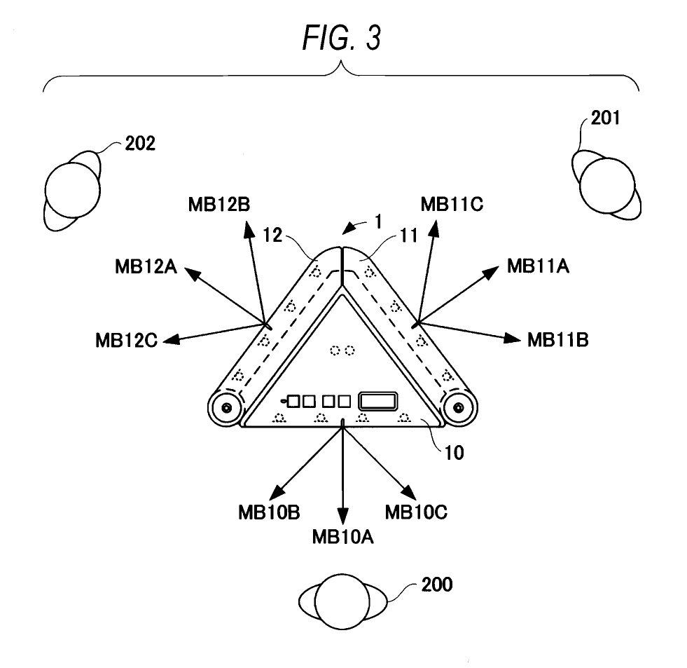

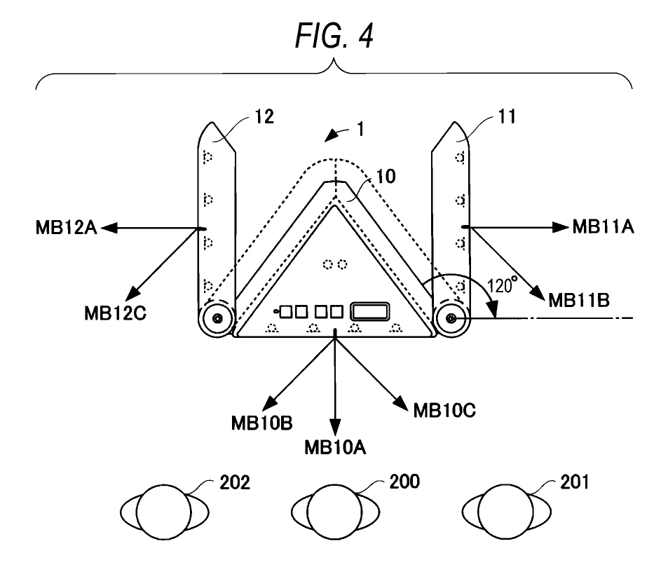

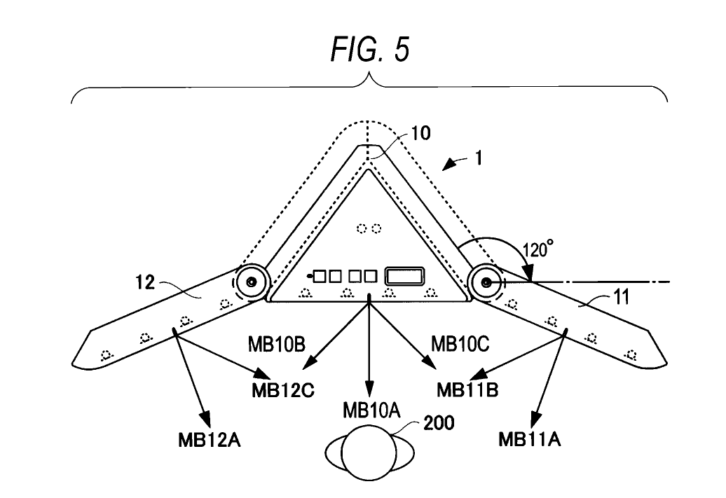

Next, details of sound collection control based on the rotation amounts of the sub-housings 11 and 12 with respect to the main housing 10 will be described with reference to FIGS. 3 to 5. FIG. 3 is a view showing an example in which multiple users 200 to 202 are seated around a sound emission and collection device. FIG. 4 is a view showing an example in which the multiple users 200 to 202 are seated in front of the sound emission and collection device. FIG. 5 is a view showing an example in which one person is seated in front of the sound emission and collection device.

First, the sound collection directions of the collected sound beam signals MB10 to MB12 will be described in detail. As shown in FIGS. 3 to 5, the collected sound beam signal MB10 includes at least one collected sound beam signal of the collected sound beam signals MB10A to MB10C. The sound collection direction of the collected sound beam signal MB10A is a direction perpendicular to the microphone array 1150, and the sound collection direction of the collected sound beam signal MB10B is a direction which is inclined by 45° clockwise with respect to the sound collection direction of the collected sound beam signal MB10A. In addition, the sound collection direction of the collected sound beam signal MB10C is a direction which is inclined by 45° counterclockwise with respect to the sound collection direction of the collected sound beam signal MB10A.

In addition, the collected sound beam signal MB11 includes at least one collected sound beam signal of the collected sound beam signals MB11A to MB11C, and the collected sound beam signal MB12 includes at least one collected sound beam signal of the collected sound beam signals MB12A to MB12C. The sound collection directions of the collected sound beam signals MB11A and MB12A are directions perpendicular to the microphone arrays 1151 and 1152 respectively, and the sound collection directions of the collected sound beam signals MB11B and MB12B are directions which are inclined by 45° clockwise with respect to the sound collection directions of the collected sound beam signals MB11A and MB12A respectively. In addition, the sound collection directions of the collected sound beam signals MB11C and MB12C are directions which are inclined by 45° counterclockwise with respect to the sound collection directions of the collected sound beam signals MB11A and MB12A respectively.

Hereinafter, sound collection control will be described. As shown in FIG. 3, in a rotation state where the entire sides of the sub-housings 11 and 12 in their long side directions are in contact with the main housing 10 (a state where all directions are set as a sound collection range using the microphone arrays 1150 to 1152, a case where the rotation amount is 0°), a sound around the sound emission and collection device 1 can be uniformly collected. Accordingly, this is suitable for a use mode in which the multiple users 200 to 202 are seated around the sound emission and collection device 1. In this case, the collected sound beam forming section 116 and the collected sound beam mixing section 117 perform the following first processing.

The collected sound beam forming section 116 generates the collected sound beam signals MB10A to MB10C on the basis of collected sound signals collected by the microphone array 1150 of the main housing 10. In addition, the collected sound beam forming section 116 generates the collected sound beam signals MB11A to MB11C on the basis of collected sound signals collected by the microphone array 1151 of the sub-housing 11. In addition, the collected sound beam forming section 116 generates the collected sound beam signals MB12A to MB12C on the basis of collected sound signals collected by the microphone array 1152 of the sub-housing 12. Then, the collected sound beam mixing section 117 performs phase control corresponding to the rotation angles on the collected sound beam signals MB10A to MB10C, MB11A to MB11C, and MB12A to MB12C and then adds the phase-controlled collected sound beam signals MB10A to MB10C, MB11A to MB11C, and MB12A to MB12C, thereby generating the collected sound beam signal MB.

Specifically, the collected sound beam mixing section 117 shifts the phase of the collected sound beam signal MB11A by the phase difference, which is equal to the angle difference between the microphone array 1150 and the microphone array 1151, with respect to the collected sound beam signal MB10A. Similarly, the collected sound beam mixing section 117 shifts the phases of the collected sound beam signals MB11B and MB11C by the phase difference, which is equal to the angle difference between the microphone array 1150 and the microphone array 1151, with respect to the collected sound beam signals MB10B and MB10C respectively. In addition, the collected sound beam mixing section 117 shifts the phase of the collected sound beam signal MB12A by the phase difference, which is equal to the angle difference between the microphone array 1150 and the microphone array 1152, with respect to the collected sound beam signal MB10A. Similarly, the collected sound beam mixing section 117 shifts the phases of the collected sound beam signals MB12B and MB12C by the phase difference, which is equal to the angle difference between the microphone array 1150 and the microphone array 1152, with respect to the collected sound beam signals MB10B and MB10C respectively. Then, the collected sound beam signals MB10A to MB10C, MB11A to MB11C, and MB12A to MB12C are added. Thus, by shifting the phase by the angles of the microphone arrays 1151 and 1152 with respect to the microphone array 1150, the sound emission and collection device 1 can collect a sound uniformly from the entire periphery of the housing and the emitted sound signal from the speaker SP collected by each of the microphone arrays 1150 to 1152 can be removed.

As shown in FIG. 4, from the rotation state where sides of the sub-housings 11 and 12 in their longitudinal side directions are not in contact with the main housing 10 to the rotation state where the sides of the sub-housings 11 and 12 are parallel to the front direction side wall of the main housing 10 (when the rotation amounts of the sub-housings 11 and 12 with respect to the main housing 10 from the basic posture shown in FIG. 3 exceeds 0° and is equal to or smaller than 120°), it is suitable for a use mode in which a display is provided at the back direction side of the front direction side wall of the main housing 10 and the multiple users 200 to 202 are seated at the front direction side of the front direction side wall of the main housing 10. In this case, the collected sound beam forming section 116 and the collected sound beam mixing section 117 perform the following second processing.

The collected sound beam forming section 116 generates the collected sound beam signals MB10A to MB10C on the basis of collected sound signals collected by the microphone array 1150 of the main housing 10. In addition, the collected sound beam forming section 116 generates the collected sound beam signals MB11A and MB11B on the basis of collected sound signals collected by the microphone array 1151 of the sub-housing 11. In addition, the collected sound beam forming section 116 generates the collected sound beam signals MB12A and MB12C on the basis of collected sound signals collected by the microphone array 1152 of the sub-housing 12. Then, the collected sound beam mixing section 117 performs phase control corresponding to the rotation angles on the collected sound beam signals MB10A to MB10C, MB11A, MB11B, MB12A, and MB12C and then adds these collected sound beam signals, thereby forming the collected sound beam signal MB. As described above, in this use mode, the sound emission and collection device 1 does not collect a sound signal from the direction in which a user would not be seated, so that an emitted sound signal of the speaker is not collected wherever possible and an influence of an emitted sound signal from the speaker SP can be suppressed.

As shown in FIG. 5, when the sides of the sub-housings 11 and 12 in their long side directions exceed the rotation state, which is parallel to the front direction side wall of the main housing 10, and are in a rotation state protruding in the front direction of the main housing 10 from the front direction side wall of the main housing 10 (when the rotation amounts exceed 120°), it is suitable for a use mode where one user 200 is seated at the front direction side of the front direction side wall of the main housing 10. In this case, the collected sound beam forming section 116 and the collected sound beam mixing section 117 perform the following third processing.

The collected sound beam forming section 116 generates the collected sound beam signals MB10A to MB10C on the basis of collected sound signals collected by the microphone array 1150 of the main housing 10. In addition, the collected sound beam forming section 116 generates the collected sound beam signals MB11A and MB11B on the basis of collected sound signals collected by the microphone array 1151 of the sub-housing 11. In addition, the collected sound beam forming section 116 generates the collected sound beam signals MB12A and MB12C on the basis of collected sound signals collected by the microphone array 1152 of the sub-housing 12. Then, the collected sound beam mixing section 117 performs phase control corresponding to the rotation angle on the collected sound beam signals MB11A, MB11B, MB12A, and MB12C and then adds these collected sound beam signals, thereby forming the collected sound beam signal MB. As described above, since the sound emission and collection device 1 does not add the collected sound beam signals collected by the microphone array 1150 of the main housing 10 which most easily collects emitted sound signals from the speaker, an influence of an emitted sound signal from the speaker SP can be suppressed. Moreover, in this use mode, although the collected sound beam forming section 116 forms the collected sound beam signals MB10A to MB10C on the basis of collected sound signals collected by the microphone array 1150 of the main housing 10, they may not be formed.

As described above, since the sound emission and collection device 1 can easily change the sound collection range simply by rotating the sub-housings 11 and 12, the sound collection range can be changed according to a use case of the user. In addition, since the sound emission and collection device 1 can perform sound collection control according to a use case of the user and can suppress emitted sound signals from the speaker SP which are collected by each of the microphone arrays 1150 to 1152, it is possible to reduce the load of the echo canceller 118.

Moreover, in the present embodiment, the control section 111 determined the sound collection directivity and a sound signal for output on the basis of the rotation amounts from the rotary encoders 1121 and 1122. However, the control section 111 may output the rotation amounts to a PC, and the PC may determine the sound collection directivity and a sound signal for output. Accordingly, the load of the sound emission and collection device 1 can be reduced.

Moreover, in the present embodiment, the rotation amounts are detected using the rotary encoders 1121 and 1122. However, other processing may also be used as long as displacement of a sub-housing with respect to the main housing 10 can be detected.

Moreover, in the present embodiment, the collected sound beam signals MB10A to MB10C, MB11A to MB11C, and MB12A to MB12C are generated. However, the number of collected sound beam signals is not limited to this embodiment but may be appropriately designed according to the specifications. For example, the microphone array 1150 of the main housing 10 may generate the collected sound beam signal MB10A in a direction perpendicular to the microphone array, a collected sound beam signal in a direction which is inclined by 30° clockwise with respect to the sound collection direction of the collected sound beam signal MB10A, a collected sound beam signal in a direction which is inclined by 60° clockwise with respect to the sound collection direction of the collected sound beam signal MB10A, a collected sound beam signal in a direction which is inclined by 30° counterclockwise with respect to the sound collection direction of the collected sound beam signal MB10A, and a collected sound beam signal in a direction which is inclined by 60° counterclockwise with respect to the sound collection direction of the collected sound beam signal MB10A.

In addition, although the sound emission and collection device 1 includes the speaker SP as an example in the present embodiment, a sound collection device which does not include the speaker SP may also be used. In this case, a speaker device may be externally connected to the sound collection device. In addition, in the case of using only a sound collection function, the speaker device is not necessary.

### Second Embodiment

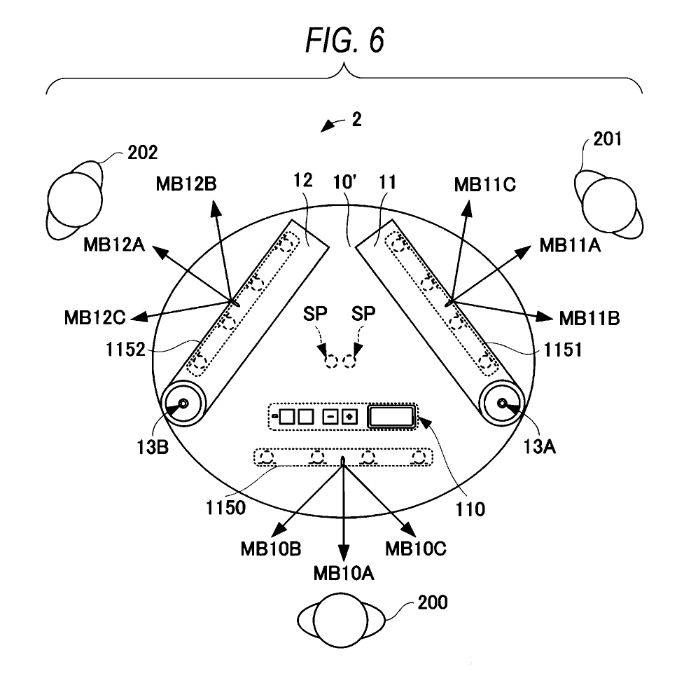

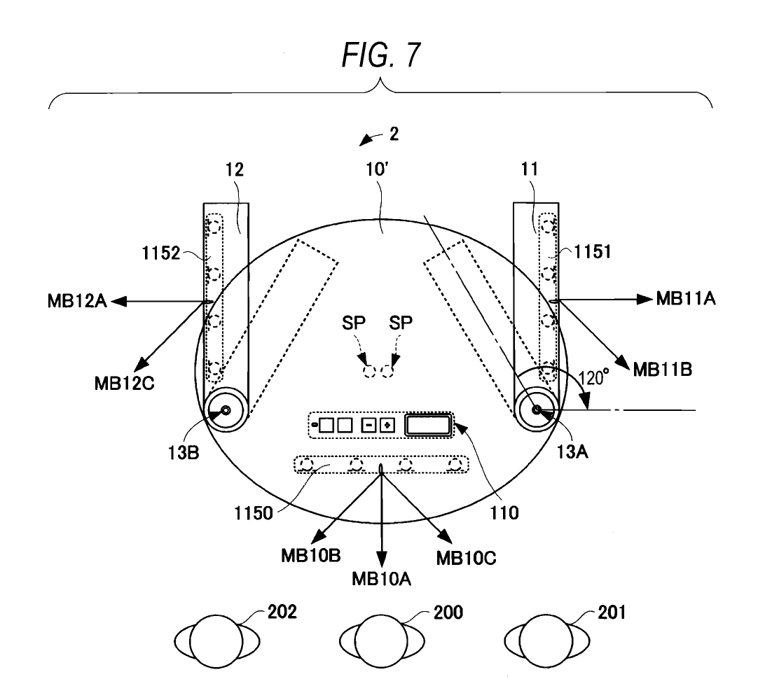

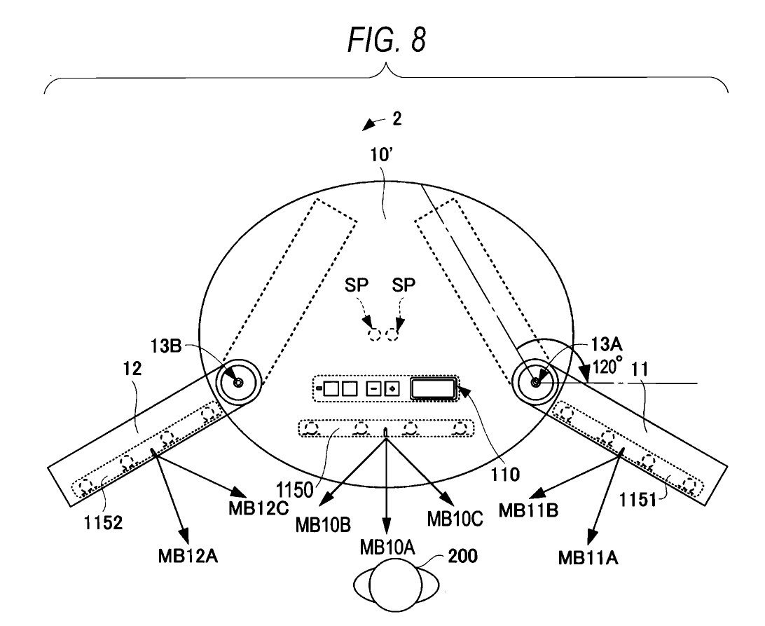

A sound emission and collection device 2 according to another embodiment will be described with reference to FIGS. 6 to 8. FIG. 6 is a plan view of a sound emission and collection device according to another embodiment. FIG. 6 is a view showing an example in which multiple users 200 to 202 are seated around a sound emission and collection device. FIG. 7 is a view showing an example in which the multiple users 200 to 202 are seated in front of the sound emission and collection device. FIG. 8 is a view showing an example in which one user 200 is seated in front of the sound emission and collection device. The sound emission and collection device 2 is different from the sound emission and collection device 1 in that the shape of a main housing 10′ is approximately elliptical in plan view. Hereinafter, only different points from the sound emission and collection device 1 will be described.

As shown in FIG. 6, the main housing 10′ of the sound emission and collection device 2 has an elliptical columnar shape. At the inner sides of front direction side walls (a side wall having a wall surface in the lower direction in FIG. 6 and a side wall of the outer periphery which is parallel to the long axis of the ellipse) of the main housing 10′ of the sound emission and collection device 2, four microphones MIC of the microphone array 1150 are provided. A sound collection direction of the four microphones MIC is a direction from the front direction side wall to the outside. The four microphones MIC are arranged in parallel to the long axis of the ellipse.

In the sound emission and collection device 2, two speakers SP are provided at the inside approximately in the vicinity of the center of the ellipse in plan view of the main housing 10′ so as to be parallel to the front direction side wall. The speakers SP are provided and a sound collection direction of the speakers SP is a direction from the upper surface (surface in plan view in FIG. 6) of the main housing 10′ to the outside.

An operating section 110 having a plurality of operating elements is provided on the upper surface of the main housing 10′ of the sound emission and collection device 2. The plurality of operating elements are provided in parallel to the long axis of the ellipse.

In the sound emission and collection device 2, rotary connection sections 13A and 13B for connections with the sub-housings 11 and 12 are provided at both ends of the microphone array 1150 of the main housing 10′. The sub-housings 11 and 12 rotate with respect to the main housing 10′ through the rotary connection sections 13A and 13B as the rotation center.

As shown in FIG. 6, regarding the basic posture of the sound emission and collection device 2, the sub-housings 11 and 12 rotate in a direction from the upper surface of the main housing 10′ to the inside and cannot rotate any more. In this case, ends (ends which are not connected to the main housing 10′) of the sub-housings 11 and 12 are closest to each other.

According to the rotation amounts of the sub-housings 11 and 12, the sound emission and collection device 2 generates the collected sound beam signal MB as follows. In the basic posture of the sound emission and collection device 2 (when all directions are set as a sound collection range using microphone arrays 1150 to 1152, when the rotation amounts are 0°), a sound around the sound emission and collection device 2 can be uniformly collected. Accordingly, this is suitable for a use mode in which multiple users 200 to 202 are seated around the sound emission and collection device. In this case, the collected sound beam forming section 116 and the collected sound beam mixing section 117 perform the first processing described above.

As shown in FIG. 7, in a rotation state where sides of the sub-housings 11 and 12 in their longitudinal side directions are parallel to the front direction side wall (one side at which the microphone array 1150 is provided) of the main housing 10′ other than the basic posture (when the rotation amounts of the sub-housings 11 and 12 with respect to the main housing 10′ from the basic posture shown in FIG. 6 exceed 0° and are equal to or smaller than 120°), it is suitable for a use mode in which a display is provided at the back direction side of the front direction side wall of the main housing 10′ and the multiple users 200 to 202 are seated at the front direction side of the front direction side wall of the main housing 10′. In this case, the collected sound beam forming section 116 and the collected sound beam mixing section 117 perform the second processing described above.

As shown in FIG. 8, when the sides of the sub-housings 11 and 12 in their long side directions exceed the rotation state, which is parallel to the front direction side wall of the main housing 10′, and are in a rotation state protruding in the front direction of the main housing 10′ from the front direction side wall of the main housing 10′ (when the rotation amounts of the sub-housings 11 and 12 with respect to the main housing 10′ from the basic posture shown in FIG. 6 exceed 120°), it is suitable for a use mode where one user 200 is seated at the front direction side of the front direction side wall of the main housing 10′. In this case, the collected sound beam forming section 116 and the collected sound beam mixing section 117 perform the third processing described above.

As described above, since the sound emission and collection device 2 can perform sound collection control according to a use mode and can suppress emitted sound signals from the speaker SP which are collected by each of the microphone arrays 1150 to 1152, it is possible to reduce the load of the echo canceller 118.

In addition, although the shape of the main housing 10′ in plan view is an approximately elliptical shape in the present embodiment, it may be an approximately circular shape.

### Third Embodiment

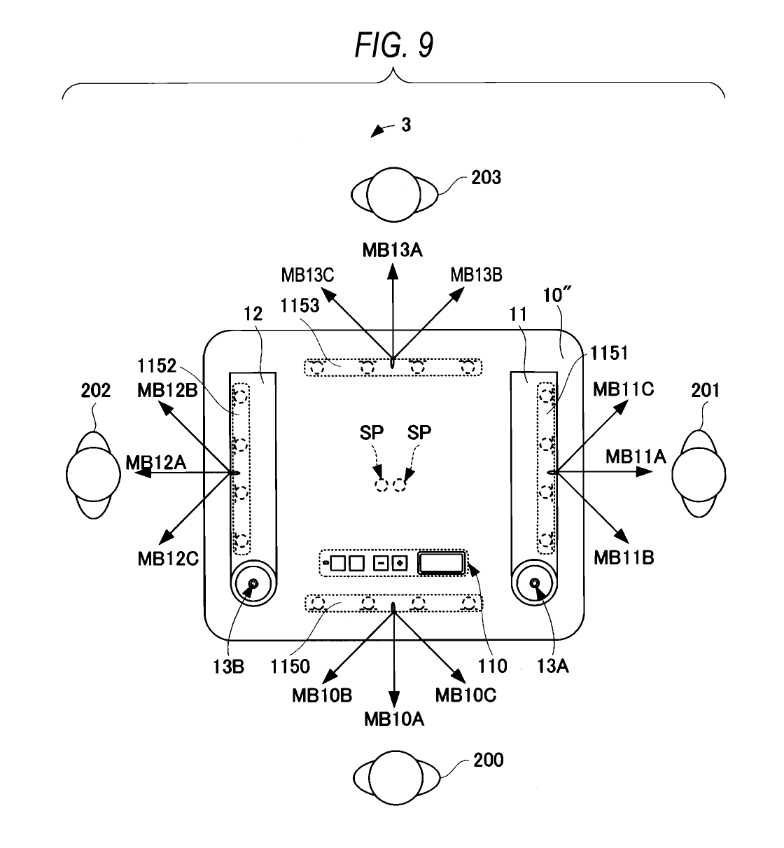

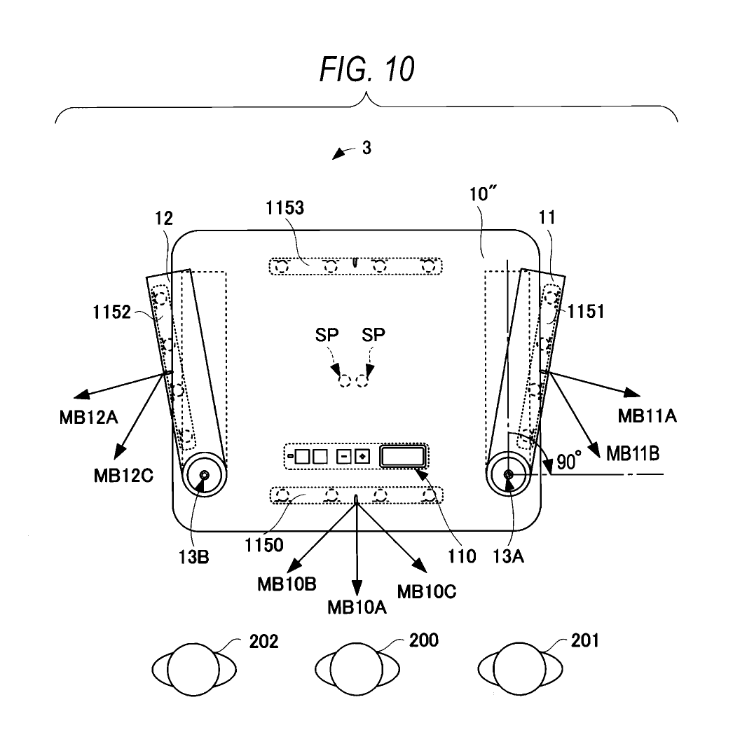

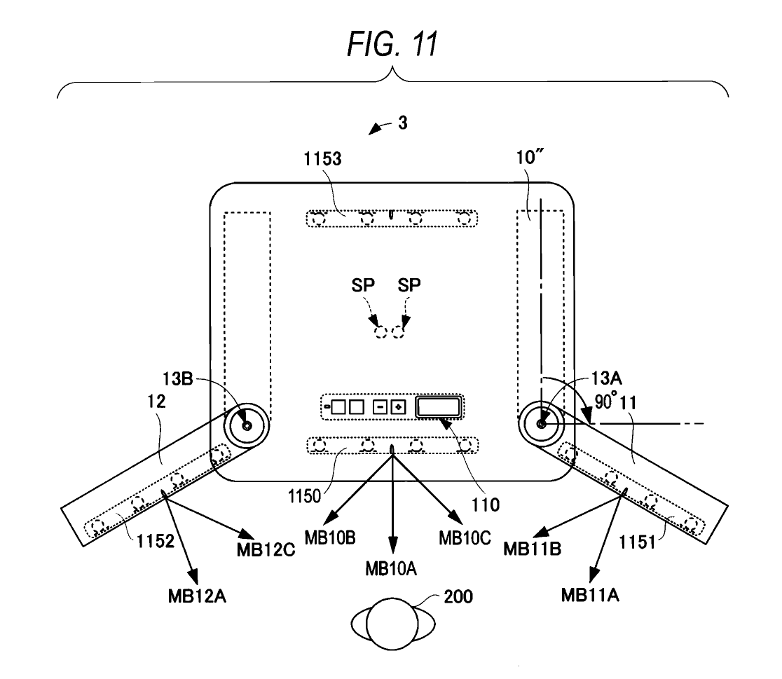

A sound emission and collection device 3 according to another embodiment will be described with reference to FIGS. 9 to 11. FIG. 9 is a view showing an example in which multiple users 200 to 203 are seated around a sound emission and collection device. FIG. 10 is a view showing an example in which the multiple users 200 to 202 are seated in front of the sound emission and collection device. FIG. 11 is a view showing an example in which one user 200 is seated in front of the sound emission and collection device. The sound emission and collection device 3 is different from the sound emission and collection device 1 in that the shape of a main housing 10″ is a rectangular shape in plan view and four microphone arrays are provided. Hereinafter, only a different point from the sound emission and collection device 1 will be described.

As shown in FIG. 9, the main housing 10″ of the sound emission and collection device 3 has a rectangular shape in plan view and has a rectangular parallelepiped shape with a predetermined thickness. In the sound emission and collection device 3, at the inner side of a front direction side wall (side wall having a wall surface in the lower direction in FIG. 9) of the main housing 10″, four microphones MIC of a microphone array 1150 are provided. A sound collection direction of the microphones MIC is a direction from the front direction side wall to the outside. At the inner side of a back direction side wall (side wall having a wall surface in the upper direction in FIG. 9) of the main housing 10″, four microphones MIC of a microphone array 1153 are provided. A sound collection direction of the microphones MIC is a direction from the back direction side wall to the outside.

In the sound emission and collection device 3, two speakers SP are provided at the inside approximately in the vicinity of the center of the rectangular shape in plan view of the main housing 10″ so as to be parallel to the front direction side wall.

On the upper surface (surface in plan view in FIG. 9) of the main housing 10″ of the sound emission and collection device 3, an operating section 110 having a plurality of operating elements is provided. The plurality of operating elements are arranged in parallel to the front direction side wall, as shown in FIG. 9.

In the sound emission and collection device 3, rotary connection sections 13A and 13B for connections with the sub-housings 11 and 12 are provided at portions equivalent to the corners of both ends of the front direction side wall of the main housing 10″. The sub-housings 11 and 12 rotate with respect to the main housing 10″ through the rotary connection sections 13A and 13B as the rotation center.

As shown in FIG. 9, regarding the basic posture of the sound emission and collection device 3, the sub-housings 11 and 12 are arranged perpendicular to the front direction side wall from the upper surface of the main housing 10″ and cannot rotate any more. In this case, the angle between each of the sub-housings 11 and 12 and front direction side wall of the main housing 10″ is 90°. The ends (ends which are not connected to the main housing 10″) of the sub-housings 11 and 12 come closest to both ends of a microphone array 1153 of the main housing 10″.

According to the rotation amounts of the sub-housings 11 and 12, the sound emission and collection device 3 generates the collected sound beam signal MB as follows. In the basic posture (when all directions are set as a sound collection range using microphone arrays 1150 to 1153, when the rotation amounts are 0°), a sound around the sound emission and collection device 2 can be uniformly collected. Accordingly, this is suitable for a use mode in which multiple users 200 to 203 are seated around the sound emission and collection device.

In this case, the collected sound beam forming section 116 generates collected sound beam signals MB10A to MB10C on the basis of collected sound signals collected by the microphone array 1150 of the main housing 10″. The collected sound beam forming section 116 generates collected sound beam signals MB11A to MB11C on the basis of collected sound signals collected by the microphone array 1151 of the sub-housing 11. The collected sound beam forming section 116 generates collected sound beam signals MB12A to MB12C on the basis of collected sound signals collected by the microphone array 1152 of the sub-housing 12. The collected sound beam forming section 116 generates the collected sound beam signals MB13A to MB13C on the basis of collected sound signals collected by the microphone array 1153 of the main housing 10″. Then, the collected sound beam mixing section 117 performs phase control corresponding to the rotation angle on the collected sound beam signals MB10A to MB10C, MB11A to MB11C, MB12A to MB12C, and MB13A to MB13C and then adds them, thereby generating the collected sound beam signal MB. As a result, the sound emission and collection device 3 can collect a sound uniformly from the entire periphery and remove an emitted sound signal from the speaker SP which is collected by each of the microphone arrays 1150 to 1153.

As shown in FIG. 10, in a rotation state where sides of the sub-housings 11 and 12 in their longitudinal side directions are parallel to the front direction side wall (one side at which the microphone array 1150 is provided) of the main housing 10″ other than the basic posture (when the rotation amounts of the sub-housings 11 and 12 with respect to the main housing 10″ from the basic posture shown in FIG. 9 exceed 0° and are equal to or smaller than 90°), it is suitable for a use mode in which a display is provided at the back direction side of the front direction side wall of the main housing 10″ and the multiple users 200 to 202 are seated at the front direction side of the front direction side wall of the main housing 10″. In this case, the collected sound beam forming section 116 and the collected sound beam mixing section 117 perform the second processing described above. In addition, since the collected sound beam signals MB13A to MB13C based on collected sound signals collected by the microphone array 1153 of the main housing 10″ are not added by the collected sound beam mixing section 117, the collected sound beam forming section 116 may not form the collected sound beam signals MB13A to MB13C.

As shown in FIG. 11, when the sides of the sub-housings 11 and 12 in their long side directions exceed the rotation state, which is parallel to the front direction side wall of the main housing 10″, and are in a rotation state protruding in the front direction of the main housing 10″ from the front direction side wall of the main housing 10″ (when the rotation amounts of the sub-housings 11 and 12 with respect to the main housing 10″ from the basic posture shown in FIG. 9 exceed 90°), it is suitable for a use mode where one user 200 is seated at the front direction side of the front direction side wall of the main housing 10″. In this case, the collected sound beam forming section 116 and the collected sound beam mixing section 117 perform the third processing described above. In addition, since the collected sound beam signals MB13A to MB13C based on collected sound signals collected by the microphone array 1153 of the main housing 10″ are not added by the collected sound beam mixing section 117, the collected sound beam forming section 116 may not form the collected sound beam signals MB13A to MB13C.

As described above, since the sound emission and collection device 3 can perform sound collection control according to a use mode and can suppress emitted sound signals from the speaker SP which are collected by each of the microphone arrays 1150 to 1153, it is possible to reduce the load of the echo canceller 118.

In addition, although the shape of the main housing 10″ in plan view is a rectangular shape in the present embodiment, it may be an approximately polygonal shape.

The present invention is based on Japanese Patent Application (Patent Application No. 2008-082511) filed on Mar. 27, 2008 and Japanese Patent Application (Patent Application No. 2009-064510) filed on Mar. 17, 2009, the entire contents of which are incorporated herein by reference.

1. A sound processing apparatus comprising:
a main housing in which a microphone array is provided at a side wall thereof;
a plurality of sub-housings that are rotatably connected with both ends of one side of the main housing as the rotation center, the microphone array being provided at the one side of the main housing, wherein microphone arrays are provided on the plurality of sub-housings respectively;
a relative positional relationship detecting section that detects a rotation amount of each of the sub-housings with respect to the main housing and detects a relative position of each of the sub-housings with respect to the main housing based on the rotation amount; and
a sound collection control section that generates a plurality of collected sound beam signals based on a sound collected by the microphone arrays of the main housing and the plurality of sub-housings in accordance with a sound collection range corresponding to the relative position.

2. The sound processing apparatus according to claim 1, wherein a speaker is provided on the main housing; and
wherein the sound collection control section performs phase control and addition processing for the collected sound beam signals respectively to suppress an emitted sound component of the speaker in a sound signal subjected to the addition processing.

3. The sound processing apparatus according to claim 2, wherein when the relative positional relationship detecting section detects an arrangement for all-direction sound collection, in which the sound collection range includes all directions in all of the microphone arrays of the main housing and the sub-housings, the sound collection control section uniformly collects a sound in all directions by the plurality of collected sound beam signals and executes a first sound collection control pattern for controlling phases of the collected sound beam signals based on an angle formed by main directions of the collected sound beam signals and adding the phase controlled collected sound beams signals.

4. The sound processing apparatus according to claim 3,
wherein when the relative positional relationship detecting section detects that an end of the microphone array of each of the sub-housings, opposite to an end which is connected to the main housing, do not exceed an extension line of the one side of the main housing at which the microphone array is provided, different from the arrangement for all-direction sound collection, the sound collection control section executes a second sound collection control pattern for forming and adding the collected sound beam signals from a direction, which is perpendicular to the microphone array of each of the sub-housings, to a side of a positive rotation direction which is a direction rotating from a side wall of each of the sub-housings toward the extension line.

5. The sound processing apparatus according to claim 3, wherein when the relative positional relationship detecting section detects that an end of the microphone array of each of the sub-housings, opposite to an end which is connected to the main housing, do not exceed an extension line of the one side of the main housing at which the microphone array is provided, different from the arrangement for all-direction sound collection, the sound collection control section executes a third sound collection control pattern for adding only collected sound beam signals based on the microphone arrays provided in the sub-housings.
